(19) United States
(12) Patent Application Publication
(10) Pub. No.: US 2016/0312805 A1
(43) Pub. Date: Oct. 27, 2016

(54) FOAM PUMP

(71) Applicant: Hübner GmbH & Co. KG, Kassel (DE)

(72) Inventors: Ralf Grimm, Spangenberg (DE); Frank Langenfelder, Kassel (DE)

(21) Appl. No.: 15/133,386

(22) Filed: Apr. 20, 2016

(30) Foreign Application Priority Data
Apr. 21, 2015 (EP) 15 164 415.0

(51) Int. Cl. F04F 1/18; B05B 7/00; F04B 53/10; F04B 23/02; F04B 43/00; F04B 43/08

(52) U.S. Cl. CPC F04F 1/18; F04B 43/0054; F04B 43/084; F04B 53/10; F04B 23/02; B05B 7/005

(57) ABSTRACT

A foam pump comprising a pump bellows, wherein the pump bellows have a neck at the output side, wherein the neck has a valve rod having a central bore for forming a mixing chamber, wherein the mixing chamber is in communication with the air space of the pump bellows by at least one air outlet opening, wherein a closable air inlet opening to the air space of the pump bellows is provided in the region of the neck of the pump bellows, wherein the mixing chamber is in communication with the medium chamber by a closable medium inlet opening, wherein the medium chamber is in communication with a medium container through a medium adjustment opening.

### CROSS-REFERENCE TO RELATED APPLICATIONS

This application claims priority of European patent application EP 15 164 415.0 filed on Apr. 21, 2015, the content of which is incorporated herein in its entirety.

### FIELD OF THE INVENTION

This invention generally relates to a foam pump.

### BACKGROUND OF THE INVENTION

Foam pumps are sufficiently known from the prior art. Such foam pumps are frequently used to prepare a foam from a medium which is present in pasty form, but in particular in liquid form, by mixing with air. In this respect, a medium/air mixture can be leaner or richer, that is the air portion or the medium portion in the foam can vary. The ratio between the medium and the air is set depending on the kind of medium and, as already stated, also depends on whether the mixture should be leaner or richer.

In a foam pump known from the prior art, the setting of the ratio of a medium and air is predefined in a fixed manner. This means that a change in the ratio of medium and air requires a replacement of the foam pump.

### SUMMARY OF THE INVENTION

It is now the underlying object of the invention to provide a remedy here, e.g. on a change of the medium or of the product, a replacement of the total foam pump is not necessarily required.

In accordance with one embodiment of this invention, it is proposed to use a foam pump having a pump bellows, the pump bellows having a neck at the output side, the neck having a valve rod with a central bore for forming a mixing chamber, the mixing chamber communicating with an air space of the pump bellows through at least one air outlet opening, a closable air inlet opening being provided in the region of the neck of the pump bellows in the air space of the pump bellows, the mixing chamber communicating with a medium chamber through a closable medium inlet opening, the medium chamber being connected to a medium container by a medium adjustment opening. There is now the possibility due to the medium adjustment opening in the medium container of setting a richer or leaner air/medium mixture or of adjusting the air/medium mixture to a changed product to be foamed by varying the diameter or the opening width of the medium adjustment opening. Provision can in particular be made for changing the medium adjustment opening by inserting a reducing piece into the medium adjustment opening, the reducing piece having an inner diameter which is matched to a desired mixing ratio between the medium and air. As already stated, it is thus possible to set the mixture as richer or leaner in a simple and inexpensive manner, or to set the mixture ratio to a changed medium, for example.

The valve rod has an actuation plate for the pump bellows at the output side. The foam pump is inserted together with a medium container, for example a plastic bottle, into a dispenser device. The dispenser device comprises a lever which is connected to the actuation plate by which the bellows pump can be actuated.

As stated earlier, a closable air inlet opening to the air space of the pump bellows is provided. This air inlet opening is arranged in a transition region of the neck of the pump bellows to the actuation plate. It becomes clear from this that the air inlet opening is provided between the front-side end of the neck and the actuation plate. The air inlet opening is closable by at least one seal, e.g. an O ring, that is a so-called soft seal. The use of such soft seals has the advantage that the corresponding opening closes tightly due to the seal and the tolerances of the seal elements can be selected as comparatively large.

A further feature of the invention is that the valve rod can be received by the pump bellows movable relative to the pump bellows and can be received movable in the neck of the pump bellows. It becomes clear from this that on actuation of the actuation plate, the valve rod is displaceably supported within the pump bellows, and is displaceably supported within the neck of the pump bellows.

As stated earlier, that the foam pump comprises a medium chamber. The medium chamber is in communication with the mixing chamber through a closable medium inlet opening. The medium inlet opening is closable by a valve rod seal, with the valve rod seal contacting the valve rod in a manner displaceable relative to the medium inlet opening so that the valve rod is movable relative to the valve rod seal. The valve rod seal displaceably contacts the wall of the medium chamber. This means that the valve rod seal takes on two functions. The first function of the valve rod seal comprises closing the medium inlet opening. The valve rod seal, which is likewise configured as a so-called soft seal, releases the medium inlet opening after displacement of the valve rod by a specific value. The valve rod seal is displaceably supported on the valve rod in a groove in the region of the medium inlet opening of the valve rod seal. If the valve rod is now displaced and displaced into the medium chamber, the valve rod seal is displaced so far in the groove until the medium inlet opening is released. In order now to allow a penetration of the medium located in the medium chamber, for example a liquid soap, into the mixing chamber, the valve rod together with the valve rod seal is pushed further into the medium chamber. Due to the reduction of the residual volume of the medium chamber, the medium now moves through the medium inlet opening via a valve rod bore arranged in the valve rod into the mixing chamber of the valve rod. It becomes clear from this that the valve rod acts in the manner of a piston in the region of the medium chamber, with the valve rod seal having a function similar to a piston ring.

The medium chamber is configured as dome-like and the medium adjustment opening is arranged at the front-side end of the medium chamber. The medium adjustment opening is represented in the simplest case as a bore, with it already having been explained at another point that the size or diameter of the medium adjustment opening can be variable, and indeed by inserting a so-called reducing piece. It has already been pointed out that the valve rod acts as a piston in conjunction with the valve rod seal in the region of the medium chamber. The quantity of medium flowing into the medium inlet opening depends on how high is the pressure increase, which is effected by displacing the valve rod into the medium chamber. If the medium adjustment opening is comparatively large, the counter pressure by the medium on the displacement of the valve rod into the medium chamber will be smaller than if the medium adjustment opening is selected as comparatively small. It becomes clear from this that the air/medium mixture is comparatively leaner with a medium adjustment opening large in diameter than with a medium adjustment opening of a smaller diameter with the same medium.

In accordance with another embodiment of this invention, the pump bellows are configured as a concertina-like bellows, with the concertina-like bellows advantageously being configured as tapering conically toward the neck. The concertina-like bellows are self-erecting, which means that the concertina-like bellows endeavors to adopt its original position again after a deformation. This is relevant against the following background. It has already been pointed out that the air inlet opening is sealed by at least one O ring in the transition region from the front-side end of the neck to the actuation plate. If it is now first supposed that the bellows is in the compressed state and if it is assumed that when the actuation plate is no longer under any load, the concertina-like bellows return to the starting position due to their inherent returning force, with then the O ring first still being pressed in the direction toward the actuation plate by the front-side of the neck, with the consequence that the air inlet opening remains closed for a brief moment in the transition region of the neck to the pump bellows, with this brief moment, however, being sufficient to draw the foam which is outside the mixing chamber back into the mixing chamber due to the vacuum in the pump bellows. It must be pointed out in this connection that the actuation plate for the dispenser device has a collar arranged at the outlet side, with the collar serving the reception of a screen insert, with the screen insert having a fabric at both ends, with the fabric serving the foam formation. The foam in this screen insert is drawn back, that is no dripping occurs.

Another feature of this invention is that the pump bellows are in communication with a housing, with the housing having a housing rim for receiving the medium container. It becomes clear from this that the medium container, for example a plastic bottle, can be plugged or screwed on the housing rim.

### BRIEF DESCRIPTION OF THE DRAWINGS

In the following, the invention is exemplarily described in more detail by means of the drawings and based on the foam pump.

FIG. 1 is a cross-sectional view of one embodiment of a foam pump.

### DETAILED DESCRIPTION OF THE PREFERRED EMBODIMENTS

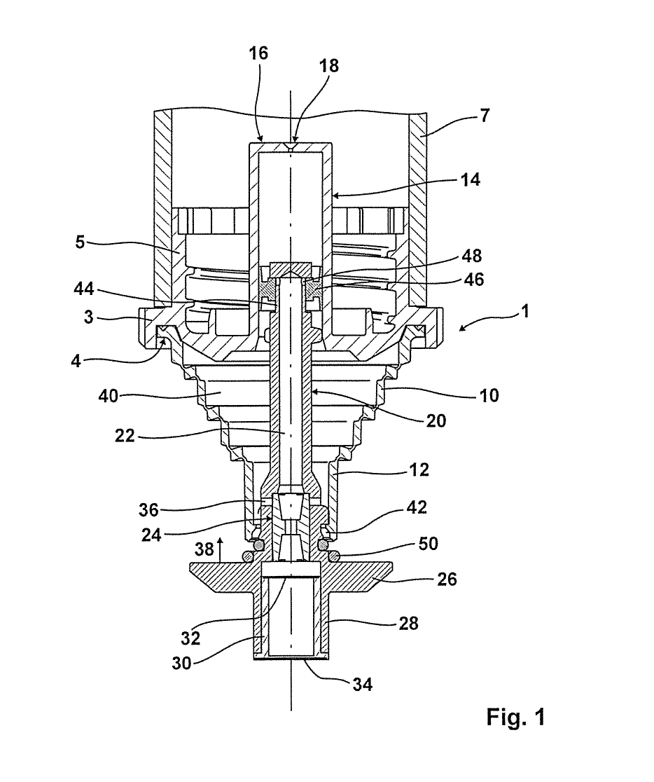

According to FIG. 1, the foam pump is labelled 1. The foam pump 1 comprises the housing 3 having the housing rim 5 onto which the medium container 7 can be plugged, as can be seen schematically from the drawing. The housing 3 receives the pump bellows 10, with the pump bellows being configured as a concertina-like bellows tapering conically toward the neck 12. The housing 3 is provided with a corresponding peripheral groove 4 for receiving the pump bellows 10 by the housing 3.

The housing not only comprises the housing rim 5 for receiving the medium container 7, but furthermore also has the dome-like medium chamber 14. The medium chamber 14 has the medium adjustment opening 18 in the front-side base 16. The medium adjustment opening 18 is configured such that a reducing piece (not shown) can be inserted there in order to be able to design the clear diameter of the medium adjustment opening 18 as variable. This will be looked at again at another point.

The neck 12 receives the valve rod designated as a whole by 20 displaceably relative to the neck 12. The valve rod 20 comprises a valve rod bore 22 which the mixing chamber 24 adjoins in the region of the neck 12. The valve rod 20 furthermore shows the actuation plate 26 for the dispenser device (not shown) at the output-side end, with the actuation plate 26 having an actuation plate collar 28 which serves the reception of the screen insert designated by 30, with the screen insert 30 showing a respective fabric 32, 34 at the upper end and at the lower end. The two fabrics 32 and 34 co-provide the foam formation. The valve rod 20 has a plurality of air outlet openings 36 distributed about the periphery in the region of the mixing chamber 24, with the air present in the air space 40 of the pump bellows 10 being pressed through the air outlet openings 36 into the mixing chamber 24 on a displacement of the actuation plate 26 in the direction of the arrow 38 on a deformation of the pump bellows 10 configured as a concertina-like bellows. On a displacement of the actuation plate 26 in the direction of the arrow 38, the air inlet opening 42 is in this respect closed in the transition region of the neck 12 to the actuation plate 26.

If now the end of the valve rod 20 at the top in the drawing is looked at, a peripheral groove 44 is recognized in the valve rod 20. The valve rod seal 46 is supported in the peripheral groove. The axial extent of the valve rod seal in the groove 44 is smaller than the length of the groove 44, and indeed by the size of the medium inlet openings 48 arranged peripherally in the region of the groove in the valve rod 20 so that when the valve rod is displaced in the direction of the arrow 38, the valve rod seal 46 will move along the groove 44 downwardly in the drawing in order thus to release the medium inlet openings 48 arranged distributed over the periphery in the groove of the valve rod. The medium arranged in the medium chamber 14, for example a liquid soap, then flows through these medium inlet openings into the valve rod bore 22 and through the valve rod bore 22 into the mixing chamber 24. If the valve rod now continues to be displaced in the direction of the arrow 38, the valve rod 20 acts in conjunction with the valve rod seal 46 in the upper region, that is in the region of the medium chamber 14, in the manner of a piston with a piston ring and displaces the liquid medium present in the medium chamber 14, e.g. the previously mentioned liquid soap, with this medium in the medium chamber moving due to the increased pressure in the medium chamber through the medium inlet opening 48, as already stated, into the valve rod bore 22. During the displacement of the valve rod 20 in the direction of the arrow 38 in the dome-like medium chamber 14, the valve rod seal 46 slides along the inner wall of the medium chamber 14, that is, as likewise already stated, the valve rod 20 in conjunction with the valve rod seal 46 in this respect acts in the manner of a piston.

It has now already been pointed out at another point that the medium adjustment opening 18 is located in the front-side base 16 of the medium chamber 14. This medium adjustment opening is variable with respect to its cross-section, for example in that a reducing piece can be introduced here whose inner diameter is smaller than the diameter of the medium adjustment opening 18. If the cross-section of the medium adjustment opening 18 is now selected as large, a comparatively large amount of the medium will escape through the medium adjustment opening 18 into the medium container 7 on a displacement of the valve rod 20 in the direction of the arrow 38 at a corresponding pressure in the medium chamber 14; however, comparatively little will penetrate through the medium inlet opening 48 into the valve rod bore 22, which can also be called a mixing bore. This means that the mixture in the mixing chamber will be comparatively leaner with a predefined amount of air which is determined by the volume of the air space 40 of the pump bellows 10 than is the case when the medium adjustment 18 is selected as smaller in cross-section and then comparatively more medium will penetrate into the valve rod bore 22 through the medium inlet opening 48. This means that in this case the mixture between air and medium then becomes richer.

If now the actuation plate 26 is released, that is if the pump bellows 10 is relieved, the pump bellows 10 then endeavors to move back into its starting position, as is shown in the drawing. That is, the pump bellows erects itself. At the start of the return movement of the bellows, however, the front-side end of the neck 12 still presses onto the seal 30 which is formed as an 0 ring in the present case. That is, at the start of the return of the pump bellows 10 a vacuum arises in the region of the mixing chamber 24, with the foam mixture present in the region of the actuation plate collar 28 being drawn back into the mixing chamber by this vacuum. If the air inlet opening 42 is then released, that is the front-side end of the neck 12 releases the seal 50, air flows from the outside into the air space 40 of the pump bellows 10. If the bellows has reached its starting position or its starting location, as shown in the drawing, the pump process can start again, starting with a displacement of the actuation plate 36 in the direction of the arrow 38.

### LIST OF REFERENCE NUMBERS

1 foam pump

3 housing

4 groove

5 housing rim

7 medium container

10 pump bellows

12 neck

14 medium chamber

16 base

18 medium adjustment opening

20 valve rod

22 valve rod bore

24 mixing chamber

26 actuation plate

28 actuation plate collar

30 screen insert

32 fabric

34 fabric

36 air outlet opening

38 arrow

40 air space

42 air inlet opening

44 groove

46 valve rod seal

48 medium inlet opening

50 seal

1. A foam pump comprising:
a pump bellows internally defining an air space and having a neck at an output side of the pump bellows;
a valve rod extending through the neck, the valve rod having a central bore forming a mixing chamber and at least one air outlet opening, the mixing chamber being in communication with the air space of the pump bellows through the at least one air outlet opening;
a closable air inlet opening defined in a region of the neck, the closable air inlet opening communicating with the air space of the pump bellows;
a medium chamber, the mixing chamber being in communication with the medium chamber by a closable medium inlet opening;
a medium container, the medium chamber being in communication with the medium container through a medium adjustment opening.

2. The foam pump in accordance with claim 1, wherein the valve rod further comprises an actuation plate for the pump bellows disposed at the output side of the pump bellows.

3. The foam pump in accordance with claim 2, wherein the neck has a transition region to the actuation plate, the closable air inlet opening to the air space of the pump bellows being defined in the transition region.

4. The foam pump in accordance with claim 1, further comprising:
a seal disposed in the closable air inlet opening such that the closable air inlet opening is at least closable by the seal.

5. The foam pump in accordance with claim 4, wherein the seal is an O-ring.

6. The foam pump in accordance with claim 1, wherein the valve rod is movable relative to the pump bellows and the neck of the pump bellows.

7. The foam pump in accordance with claim 1, further comprising a valve rod seal configured to close the medium inlet opening, the valve rod seal contacting a wall of the medium chamber and the valve rod being movable relative to the valve rod seal.

8. The foam pump in accordance with claim 1, wherein the medium chamber is dome-shaped and has a base, the medium adjustment opening being located in the base at the front-side end of the medium chamber.

9. The foam pump in accordance with claim 1, wherein the pump bellows is a concertina-like bellows.

10. The foam pump in accordance with claim 1, wherein the pump bellows conically taper toward the neck.

11. The foam pump in accordance with claim 2, wherein the actuation plate further comprising a screen insert.

12. The foam pump in accordance with claim 1, further comprising a housing having a housing rim for receiving the medium container.

13. The foam pump in accordance with claim 1, wherein the medium adjustment opening is variable in size.

14. The foam pump in accordance with claim 13, further comprising a reducing piece that is insertable into the medium adjustment opening.

15. The foam pump in accordance with claim 7, wherein the valve rod seal displaceably contacts the wall of the medium chamber.
